(19) United States
(12) Patent Application Publication
(10) Pub. No.: US 2004/0177325 A1
(43) Pub. Date: Sep. 9, 2004

(54) Edit location indicator

(76) Inventors: Robert S. Keane, Arlington, MA (US); Kenneth A. Walker JR., Somerville, MA (US)

Correspondence Address: VISTA PRINT USA INC., 100 HAYDEN AVENUE, LEXINGTON, MA, 02421, US

(21) Appl. No.: 10/384,507

(22) Filed: Mar. 7, 2003

(51) Int. Cl. G06F 15/00

(52) U.S. Cl. 715/530

(57) ABSTRACT

Systems, methods and computer program products are disclosed for providing an edit location indicator. The indicator is displayed to a user while the user is performing editing actions to create an electronic document design that is intended to undergo subsequent printing and processing to produce a printed product. The indicator has a number of individually modifiable sections, each indicator section corresponding to a physical section of the type of product being designed. When the user performs an electronic edit action, the section of the product corresponding to the location of the edit action is identified and the corresponding section of the indicator is modified to present to the user a visual indication of the section of the product affected by the edit action.

### BACKGROUND OF THE INVENTION

1. Field of the Invention

The present invention relates generally to electronic documents and, more particularly, to tools for assisting a user during the editing of electronic documents.

2. Description of the Related Art

Modern Web browsers, such as Internet Explorer from Microsoft Corporation, provide support for the versatile and powerful markup languages and standards in use today, such as XHTML (eXtensible Hypertext Markup Language), Cascading Style Sheets, Document Object Module, and scripting. These technologies allow software applications to be downloaded over the World Wide Web to a user's computer and run in the user's browser.

Among the many new businesses that are taking advantage of the capabilities of the Web are printing service providers that provide document design and printing services for users desiring to obtain quantities of high quality, color documents of the type that the user is not capable of producing with the printer systems typically connected to most computer systems. These printing service providers typically provide their customers with the ability to access the printing service provider's web site, download product templates and a product design program, create a customized markup language document in the browser of the user's computer system, and upload the document to the printing service provider's server for subsequent printing. Web-based printing service providers will also typically retain documents created by users for a period of time in case a user desires to review or edit a document created earlier.

One network-based product design system is disclosed in U.S. Pat. No. 6,247,011 entitled “Computerized Prepress”. The patent discloses a document-authorizing tool that is downloaded from a server and runs in the client browser. The tool allows the user to create a markup language version of a product intended for uploading to the server for subsequent printing. Another system is disclosed in co-pending and co-owned U.S. application Ser. No. 09/557,571 entitled “Managing Print lobs”, which is hereby incorporated by reference. The system discloses a downloadable editing tool that allows a customer to create and edit WYSIWYG markup language documents in the customer's browser. The system makes a number of pre-designed product templates available for customer viewing, downloading, and customizing. The customer can upload the electronic document to a server and place an order for production of the printed products.

For some types of documents being viewed and edited by a user in the user's browser, the user can easily determine the configuration of the document and the area of the document currently being edited. For example, business cards and standard size postcards are relatively small documents that generally have easily distinguishable front and back sides. Images of these documents can usually be displayed in full-size, and sometimes larger, on the user's display screen without cropping of the document image. This allows the user to see the entire side of the document at one time while editing or reviewing the document. The typical user involved in designing these types of documents has no difficulty keeping track of where edits are being performed. This is not necessarily the case with larger format documents.

Instances of displaying a reduced size version of an image as an aid to the user while the user is viewing only a section of the image are known in the prior art, but they are generally limited to use in connection with zooming or scrolling. For example, some software programs for viewing maps will display both a main viewing area and a separate, relatively small overview version of the entire map. The overview version is usually marked with a grid. If the user elects to view a segment of the map in more detail, the selected map segment will be displayed in the main viewing area and the area of the grid corresponding to that segment on the overview map will be highlighted to indicate which grid section is currently being displayed in the main viewing area. Another example of a similar prior art approach has been used in recent versions of the Adobe Photoshop product from Adobe Systems. The Photoshop product provides both a main viewing area and a smaller version of the image being viewed. The portion of the image being displayed in the main viewing window is indicated by a rectangle displayed in the overview image. The size of the rectangle increases, decreases and/or moves as the user zooms out, zooms in, or scrolls. In summary, in the prior art, the additional version of the main image is essentially a zooming/navigation tool used for indicating what portion and how much of a single larger image is currently displayed in the main viewing window.

The prior art lacks tools that provide aid and information to a user engaged in editing larger format documents and documents that are intended to undergo post-printing processing, such as folding. For documents having larger dimensions, such as 8½ by 11 inches or larger, it is likely that the user will not be able to edit the document while the entire document is displayed on the user's screen. If the user zooms out to be able to see the edges of the document, the text will be reduced to a degree that makes it difficult or impossible to read. If the user zooms in to be able to focus on a particular area of the document, the document will become cropped such that only a portion is visible to the user on the user's display. For larger format documents, therefore, there will be many times when the user will be seeing only a portion of the side of the document being edited. Some, or possibly all, of the edges of the document will not be visible on the user's computer display.

Further, many documents are designed to have text and other content printed on both sides. In the course of editing and reviewing this type of document, the user may move back and forth between the two sides of a document several times. If the two sides of a document are not clearly distinctive, some users may become confused regarding exactly which side of the document is currently editing, possibly resulting in delay, user frustration, or misplaced content.

Yet a further potential problem area for users is working with an electronic document template for designing a product that is intended to undergo post-printing processing, Such as folding operations. One familiar example of this type of document is a “three-panel” brochure. Three-panel brochures are frequently used for rack displays, as mailers, and in other applications where the designer wants to present information to the reader in a manner other than on a simple flat sheet. A common type of three-panel brochure is created by printing on both sides of an 8½ by 11 inch piece of paper in landscape orientation. The printed sheet is then folded twice to create three equal-sized panels of approximately 8½ inches by 3⅔ inches each. In a three-panel brochure, the two side panels are folded toward each other Such that one side panel overlaps the other. A similar type of brochure, the “z-fold”, has the same general appearance when flat, but undergoes a different post-printing folding process. In z-fold brochure folding, the two side panels are folded in opposite directions such that the folded brochure has the general shape of the letter Z.

When a three-panel brochure is being designed on a user's computer screen in an unfolded condition, it is difficult for some users to picture exactly how the panels of the printed product will fold and unfold. A user designing such a document may have difficulty visualizing the appearance of the document in its final physical form and may become confused regarding exactly where information will appear in the folded document or exactly what portion of the document is currently being editing. This may slow down the design process or cause the brochure designer to inadvertently place material on the wrong panel, resulting in information being presented to the brochure reader in the wrong sequence.

Therefore, a need exists for a system and method for providing a visual indication to users during the electronic document editing process of where in the product the user is currently performing edit operations.

### SUMMARY

The present invention is directed to satisfying the need for a document editing indicator system, program and method that provides a visual product edit location indication to the user involved in designing an electronic document.

In accordance with one aspect of the invention, while a user is editing a document, an edit location indictor having a plurality of individually modifiable sections is displayed to the user. Each section of the indicator corresponds to a section of the printed product being prepared. In response to a document edit command from the user, the appearance of the section of the indicator corresponding to the location of the edit in the product is modified to give the user a visual indication of the location of the edit in the product.

In accordance with another aspect of the invention, the appearance of one or more of the sections of the indicator are repetitively manipulated to simulate the folding and unfolding of the product to the user.

These and other objects, features and advantages of the present invention will be better understood with reference to the accompanying drawings, description and claims.

### BRIEF DESCRIPTION OF THE DRAWINGS

FIG. 1 is a block diagram of a computer system that is suitable for practicing the invention.

FIGS. 2A and 2B are representations of document-editing screens displayed to the user.

FIGS. 3A-3C are representations of three states of a textbox.

FIG. 4A is a representation of Edit Indicator 240 with the panels in a fully folded position.

FIG. 4B is a representation of Edit Indicator 240 with the panels in a partially folded position.

FIG. 5 is a flow chart of the edit location indication procedure.

### DETAILED DESCRIPTION

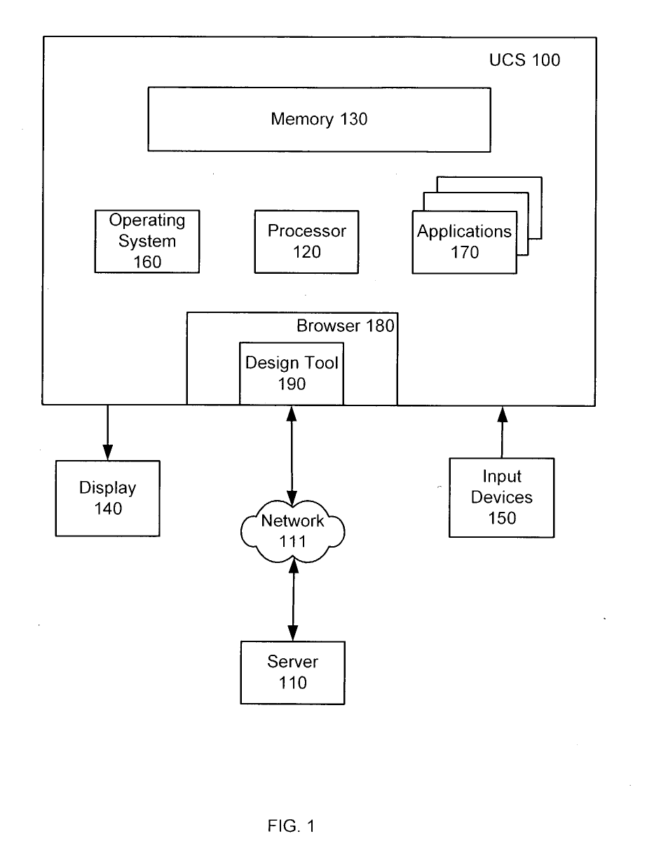

Referring to FIG. 1, an exemplary user computer system UCS 100 includes processor 120 and memory 130. Memory 130 represents all UCS 100 components and subsystems that provide data storage, such as RAM, ROM, and hard drives. In addition to providing permanent storage for all programs installed on UCS 100, Such as the operating system and various application programs, Memory 130 also provides temporary storage required by the operating system and the applications while they are executing. In a preferred embodiment, UCS 100 is a typically equipped personal computer, but UCS 100 could be also be a portable computer, a tablet computer or other device that is capable of running browser software. The user views images from UCS 100 on Display 140, such as a CRT or LCD screen, and provides inputs to UCS 100 via Input Devices 150, such as a keyboard and a mouse.

When UCS 100 is operating, an instance of the USC 100 operating system will be running, represented in FIG. 1 by Operating System 160. In addition, the user may be running one or more application programs. In FIG. 1, UCS 100 is running Web Browser 180, such as Microsoft Internet Explorer. Other applications, which may be running in USC 100, such as spreadsheet, e-mail, and presentation programs, are represented as Applications 170. Design Tool 190 is a product design program running in Browser 180. Design Tool 190 allows the user to select an appropriate product template and to use the template to prepare a customized document design in electronic form. In the exemplary embodiment, Design Tool 190 is downloaded to UCS 100 via Network 111 from remote Server 10. Alternatively, Design Tool 190 could have been obtained by the user from Memory 130 or from another local source. When the customer is satisfied with the design, the design can be uploaded to Server 110 for production of the desired quantity of the physical product on appropriate printing and post-print processing systems. (not shown).

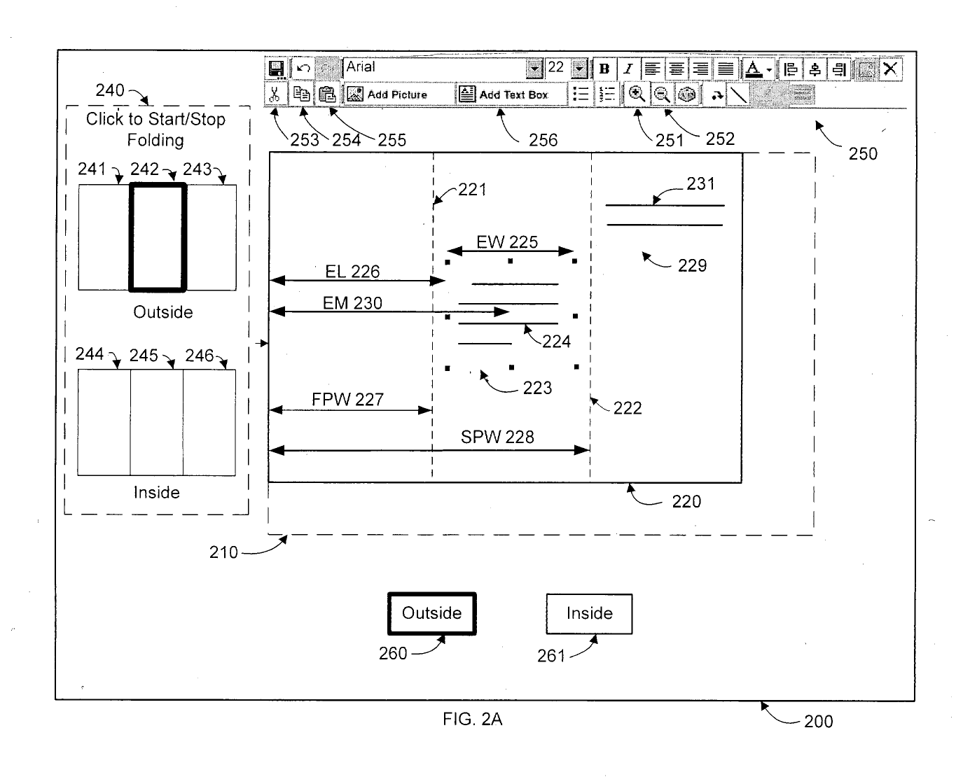

Referring to FIG. 2A, Display 200 represents a display screen being viewed by the user of UCS 100 during the editing of an electronic document. “Editing” of a document is used broadly herein to encompass all aspects of the creation and modification of a document, including all user operations or commands related to the selecting, adding, deleting, modifying, repositioning, or otherwise changing document content. The displayed information includes Edit Area 210 and Tool Bar 250. The document template that is currently being edited by the user of UCS 100, Document 220, is displayed to the user in Edit Area 210. Editing functions for the product being edited in Edit Area 210 are controlled by the user using Tool Bar 250. Tool Bar 250 contains buttons and fields controlling font type, font size, alignment, colors, lists, and other functions not directly related to the description of the preferred embodiment of the invention. Techniques for the design and operation of editing tool bars are known in the art.

In the exemplary embodiment for editing a two-sided document represented in FIG. 2, one side of Document 220 is displayed in Edit Area 210 at a time. The user can change the side of the document being displayed in Edit Area 210 using navigation buttons Outside 260 and Inside 261. Using these buttons, the user can move back and forth between the two sides of the document at will and as often as desired during the design process.

The boundaries of Edit Area 210 are not directly visible to the user. For the purpose of illustration, they are indicated in FIG. 2A by dashed lines. If the user zooms in using Zoom in button 251 such that all of Document 220 will no longer fit entirely within Edit Area 210, Document 220 will become cropped and the portion of Document 220 that extends outside of Edit Area 210 will no longer be visible to the user.

The invention will be discussed herein in the context of the design of a brochure, but it will be understood that the invention is not so limited. The term “document” is used broadly herein to refer to the electronic description of a product regardless of the form, format or content of the product or the type of material to be used for the production of the product. The document being prepared could have variable dimensions, proportions and orientation.

In FIG. 2A, Document 220 is a three-panel brochure template being displayed to the user at a reduced size. This display size allows the user to view the entire side of Document 220 within Edit Area 210. The upper left corner of document 220 is initially positioned to coincide with the upper left corner of Edit Area 210 and the left edge of Document 220 is aligned with the left edge of Edit Area 210. The user can change this initial alignment of Document 220 relative to Edit Area 210 by performing zooming and scrolling operations. Dashed lines 221 and 222 are displayed to the user during the editing process to indicate to the user where the three-panel brochure will be folded during post-printing processing. The brochure folding operation can be considered as conceptually dividing each side of the flat printed document into three distinct panels. The brochure will be printed on both sides, therefore each physical section of the folded brochure can be considered as having a panel of informational content printed on each side.

In a markup language document, text, including letters, numbers, punctuation marks, graphic elements, symbols and other characters, is typically entered, displayed and arranged in an element commonly called a textbox. For simplicity of presentation, Document 220 contains only two elements, Textboxes 223 and 229, but it will be appreciated that the markup language embodiment described herein is applicable to any Dynamic HTML, or similar markup language, elements having dimension and location properties, such as an image or a table.

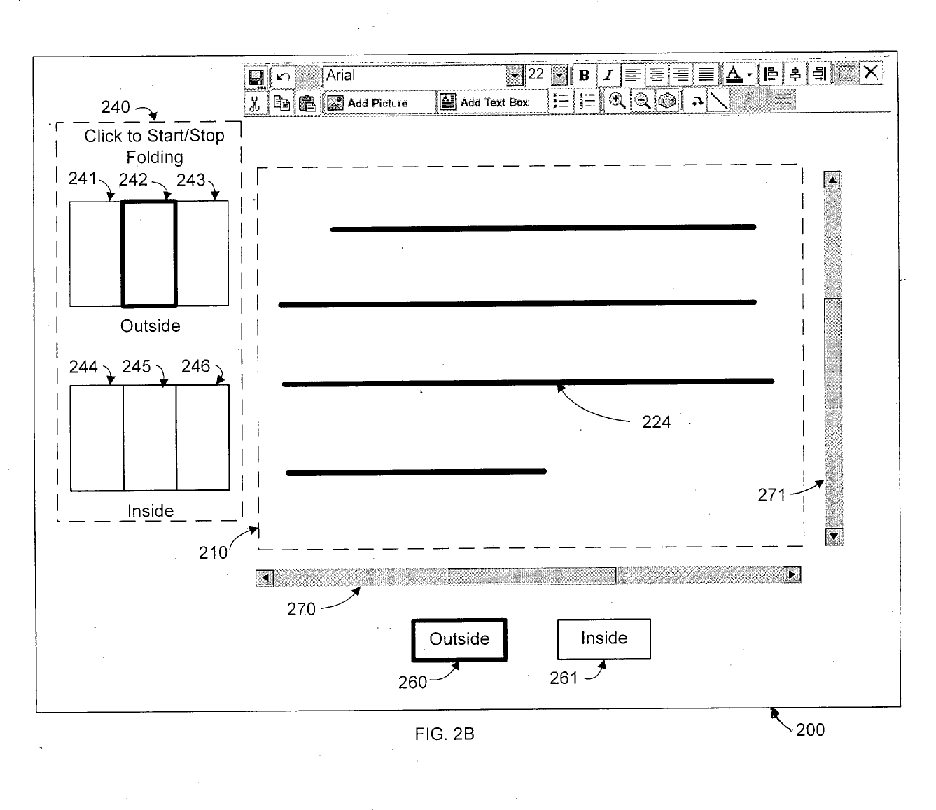

In FIG. 2A, the horizontal solid lines 224 and 231 in Textboxes 223 and 229 represent text earlier entered in the textboxes. A textbox will typically not have a visible outline unless, as discussed below in connection with FIGS. 3A-3C, the textbox has been selected by the user. In FIG. 2A, Textbox 223 has been selected, indicated by the eights dots around the perimeter of the textbox. Textbox 229 is not selected, therefore only the text content of textbox 229 is displayed.

FIG. 2B shows an example of the user having zoomed in using Zoom In button 251 to view text 224 contained in Textbox 223 in greater detail. In this case, the user has moved in until text 224 of Textbox 223 substantially fills the entire Edit Area 210. Whenever the user performs a zoom operation such that the document is no longer entirely visible in Edit Area 210, horizontal scroll bar 270 and vertical scroll bar 271 will be displayed to allow the user to navigate in the document. The zooming operations and the generation and support of the scroll bars are controlled by standard browser functions.

Also displayed to the user on screen 200 is Edit Location Indicator 240. Indicator 240 depicts relevant physical characteristics of the product being designed by the user. In this example, Indicator 240 is presented in landscape orientation, reflecting the orientation of Document 220, and, because the document being created is a folding brochure, indicator 240 includes representations of fold lines 221 and 222. As will be discussed in more detailed below, panels 241-246 of Indicator 240 will be modified in response to user edit actions in Edit Area 210 to provide to the user a visual indication of which panel in the brochure product being prepared is affected by the edit action. In an exemplary embodiment, the appropriate Indicator panel corresponding to an edit location in Document 220 is highlighted by modifying it to appear in a distinctive color that clearly identifies it to the user.

Because the user is designing a product intended to be printed on more than one side, Indicator 240 includes a reduced size outline representation of both sides of the brochure being created. The “outside” of the product, so named in this discussion because it contains the panels of the brochure that will be visible when the printed document is in a completely folded state, is represented in a first area of Indicator 240 by panels 241-243. The opposite side of the product, referred to in this discussion as the “inside”, is represented in a second area of Indicator 240 by panels 244-246. The specific terminology used to identify the two document sides could be varied, as appropriate, to reflect the type of document being prepared by the user. Outside panel 241 and inside panel 246 represent the opposite sides of the same physical section of the document. Similarly, panels 242 and 245 represent opposite sides of the same physical section, as do panels 243 and 244. To additionally differentiate the outside and inside areas of indicator 240, outside panels 241-243 are preferably displayed in one color and inside panels 244-246 are displayed in a different color.

In the exemplary embodiment, when the user begins the document editing process, the outside of the brochure is initially displayed. Using navigation buttons Outside 260 and Inside 261, the user can move between views of the two sides as desired. To provide an additional visual edit location clue to the user, the navigation button 260 or 261 that is associated with the side of the document currently being editing will be highlighted. In FIG. 2A, because the outside of the brochure is currently being displayed in Edit Area 210, Outside 260 is highlighted.

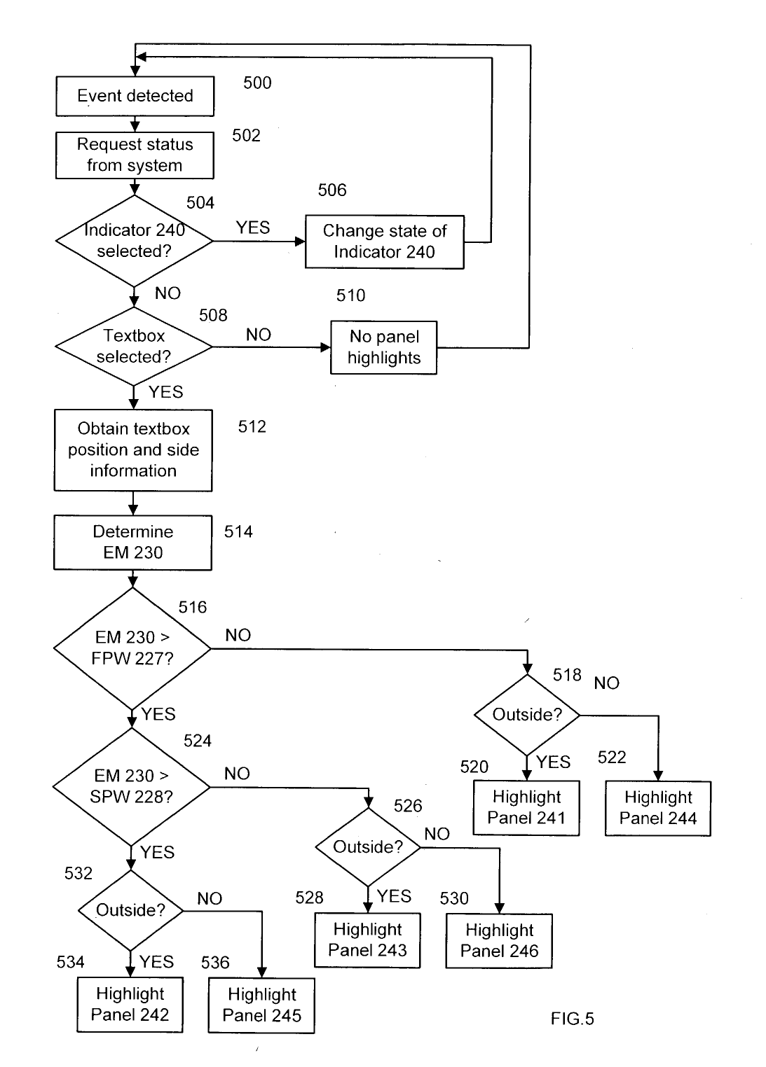

Also shown in FIG. 2A, and discussed further below in connection with FIG. 5, are Element Width (EW) 225, Element Left (EL) 226, First Panel Width (FPW) 227, Second Panel Width (SPW) 228 and Element Midpoint (EM) 230. These values are not displayed to the user, but are shown in FIG. 2A to aid in explaining the invention. EW 225 represents the width of the selected element, in this case Textbox 223. EL 226 represents the distance from the left side of Document 220 to the left edge of the selected element. These two parameters, and other element-related properties such as the element height and the vertical distance from the top of the document to the top edge of the element, are readily available from the browser. FPW 227 represents the fixed distance from the left side of Document 220 to fold line 221. SPW 228 represents the fixed distance from the left side of Document 220 to fold line 222. The distances to fold lines FPW 227 and SPW 228 are stored values predetermined by the printing service provider designer of the downloaded three-panel brochure template and are based on the post-printing folding operations to be performed on the printed document. Finally, EM 230 is the distance from the left side of Document 220 to the midpoint of the selected element. The value of EM 230 distance will be calculated by adding one-half of EW 225 to the value of EL 226. In the exemplary embodiment, as discussed below, this value is used in the control of Indicator 240. As is understood in the art, the element size and position properties provided by the browser are not affected by any zooming or scrolling operations that the user may have performed.

The number, size and location of the elements in the user's document are preferably under the control of the user. Add Textbox Button 256 allows the user to add as many new empty textboxes as the user desires. When the user clicks on Add Textbox Button 256, Design Tool 190 will create and display a new textbox in a default location. In a preferred embodiment, the default location is the left panel on the side of the document currently being displayed in Edit Area 210. Other default locations could be employed.

The user can place an element in the selected state by moving the mouse cursor anywhere over the element and executing a single mouse click. No more than one element in the document may be in the selected state at any one time. When the user selects an element, any element that had been previously in the selected state is deselected and returns to the unselected state. All elements in the document can be in the unselected state at the same time.

For each element that is unselected, the user will see only the content, if any, contained in the element. One or more elements without any content can be present in the document though they would not be visible to the user unless they are in the selected state. In a preferred embodiment, when an element is in the selected state, the boundaries of the element are indicated to the user by a set of eights dots or points. One dot is located at each corner of the element and one at the midpoint of each side. Each of these dots also functions as a handle that can be used by the user to resize the element using standard click-and-drag techniques. The user can reposition the element by clicking inside the element and dragging it to the desired location. When relatively small adjustments to the element position are desired, the user can click inside the element to select it and use the keyboard arrow keys to move the element horizontally or vertically.

Some elements that a user may choose to incorporate into a document, such as an image, will have only two possible states: unselected or selected. Textbox elements, by contrast, can be in one of three possible states: unselected, selected, or edit. Referring to FIGS. 3A-3C, examples of the three textbox states are represented. FIG. 3A represents an unselected textbox. Only the content 301 is displayed with no visible indication of the size of the element. FIG. 3B represents a selected textbox. As mentioned above, a selected element is indicated to the user by the eight dots 302. If the user clicks inside a textbox that is in the selected state, the textbox will enter the edit state. As shown in FIG. 3C, this condition is indicated to the user by the appearance of a border surrounding the textbox, indicated by dashed line 303, and by the appearance of inline text insertion cursor 304 within the textbox. In a preferred embodiment, the status of Indicator 240 is determined by a textbox or other element entering the selected state. Whether or not a selected textbox is subsequently placed in the edit state has no effect on the status of Indicator 240.

In FIG. 2A, Document 220 displayed in Edit Area 210 contains two elements, Textbox 223 and Textbox 229. The remainder of the document is “empty” until the user, if desired, inserts additional elements into the document either by adding a new empty textbox using Add Text Box button 256 or by pasting a text or image element into the document using Paste button 255. Any previously selected element will become unselected if the user clicks the mouse either inside the document in a location where no element exists or somewhere else on display 200 away from any active button or tool.

In FIG. 2A, the user has placed Textbox 223 in the selected mode. Because the user is editing the outside of Document 220 and Textbox 223 is currently selected, panel 242 in Indicator 240 has been highlighted to indicate to the user that a textbox in the middle section of the outside of Document 220 is the current active edit location. While a document is being edited, there may be many times when none of the panels 241-246 is highlighted because no textbox inside of the document is selected for editing. For example, if the user were to click with the mouse anywhere on Document 220 that is not either inside the boundaries of Textbox 223 or Textbox 229, Textbox 223 would become unselected and panel 242 would change appearance to be similar to adjacent panels 241 and 243. In this event, no panel in Indicator 240 would be highlighted until the user selects another element, such as by selecting Textbox 229, selecting Textbox 223 again or clicking Add Text Box 256 or Paste 255 to create a new textbox. As mentioned above, clicking Add Text Box 256 places the new text box in a default initial position on the left panel of Document 220. This will cause panel 241 to be highlighted.

In the exemplary embodiment, the decision of which Indicator panel to highlight is based on the horizontal midpoint of the selected element. A change to Indicator 240 panel can also be caused by editing actions that affect the position or size of an element that is already selected. For example, if the user drags or resizes an element such that the midpoint of the element moves to a different panel, when the user completes the action, typically by releasing the mouse button, the new location of the midpoint will be calculated and the panels of Indicator 240 will be appropriately modified.

Two other situations relevant to the operation of Indicator 240 in a preferred embodiment will be mentioned for completeness. Copying of an element is performed by clicking Copy button 254 while an element is selected. The original element remains visible to the user and the panel in Indicator 240 corresponding to the location of the copied element remains highlighted. Cutting of an element is performed by clicking Cut button 253 while an element is selected. After the cutting operation, the original selected element is removed from Document 220 and is no longer displayed to the user. In this situation, even though the element is no longer displayed, the Indicator 240 panel corresponding to the panel where the element formerly was displayed remains highlighted.

In a preferred embodiment, each of the six panels 241-246 is implemented as a separate VML (Vector Markup Language) object. VML is a well-known application of XML (eXtensible Markup Language) and is specifically adapted to provide a format for combining vector information defining a shape, or group of shapes, along with markup information describing how the vector information may be displayed and edited. To enhance the ability of the user to properly visualize the physical configuration of Document 220 after printing and folding, Indicator 240 is implemented with dynamic capabilities. When activated by the user, the Indicator 240 images will transition between the folded and unfolded states to simulate the folding and unfolding of the brochure. This will assist the user in visualizing the manner in which the panels of the brochure will be seen and perceived by a reader. The Formulas element of VML supports a number of mathematical and trigonometric calculations and allows the display of a VML shape to be modified according to the results. As is understood by those of skill in the alt, the VML Formulas element can be used to calculate changes in how a shape would appear in two-dimensions as the result of changes in the position of the viewer of the shape or movement of the shape in two- or three-dimensional space. Other languages that provide support for similar calculations could also be employed.

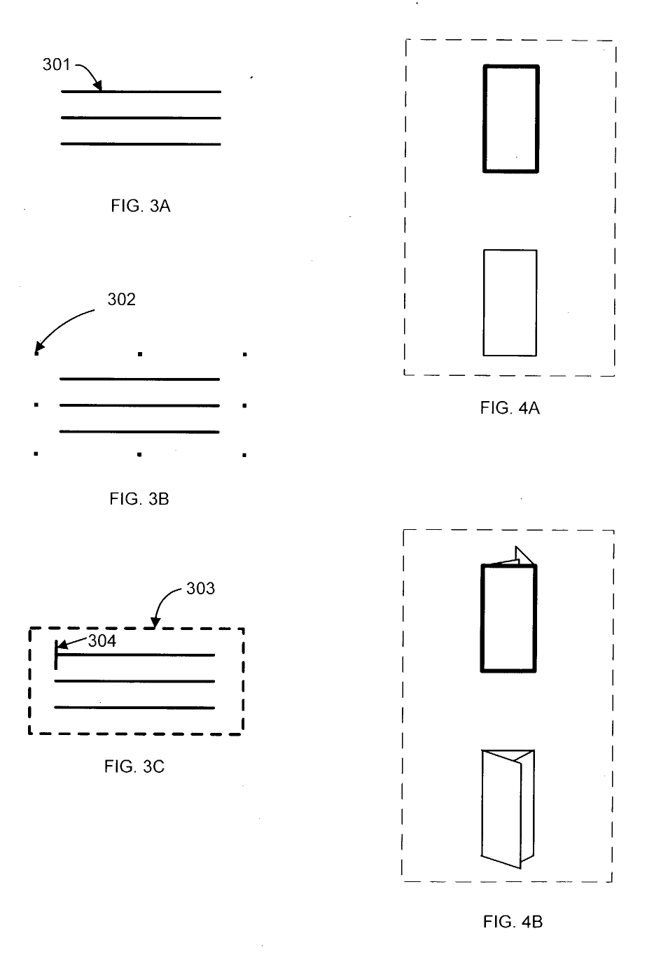

The dynamic movement simulation of indicator 240 will now be described with reference to FIG. 2A and FIGS. 4A and 4B. In FIG. 2A, indicator 240 initially shows the outside and inside of the brochure in the fully open position. As indicated to the user by the instruction “Click to Start/Stop Folding” displayed above panels 241-243, the user can initiate an animated folding/unfolding display by moving the mouse cursor over any of the panels 241-246 and clicking. When activated by the user, Indicator 240 will show the transition between the fully unfolded position, depicted in FIG. 2A, and the fully folded position, depicted in FIG. 4A. In a preferred embodiment, the simulation of the folding and unfolding of the product will continue until stopped by the user. The user can stop the folding/unfolding process at any time by moving the mouse cursor over indicator 240 and again clicking on any one of the panels.

FIG. 4B illustrates an intermediate position. As shown in FIG. 4B, in a preferred embodiment, the folding and unfolding of indicator 240 is rendered as though the user is viewing the brochure from a slightly elevated position. This perspective allows the user to better visualize the individual panels and the folding/unfolding process. To further simulate the manner in which a human reader would manipulate the printed brochure, the movement of the outside panels is done in a staggered fashion. That is, panels 241 and 246 start and finish the folding process slightly sooner than panels 243 and 244. Similarly, panels 243 and 244 start and finish the unfolding process slightly sooner than panels 241 and 246. In a preferred embodiment, each moving panel performs its folding or unfolding process in approximately 5 seconds, with one of the folding panels starting the process approximately one second before the other panel. For example, from the fully unfolded position, panel 241 will start to move approximately one second before panel 243. As indicated in FIG. 4B, this allows the panels to fold in the correct sequence.

The proper realistic display of the folding panels is accomplished by the appropriate setting of the z-index values for the individual VML panel objects. When multiple VML objects are positioned such that they overlap, the z-index assigned to each object controls the order in which the objects are layered to create a composite image. For example, referring to the three Inside panels in FIG. 4B, left panel 244 has the highest z-index of the three panels and, therefore, it appears above the other two panels in the composite image. Right panel 246 has the next highest z-index and appears between the other two panels. Middle panel 245 has the lowest z-index value and is, therefore, placed at the lowest position in the composite image. The Outside panels represent the same brochure viewed from the other side, therefore, middle panel 242 has the highest z-index in the Outside composite image.

If an observer were to view the folding process from above, each of the two outer physical panels of a printed brochure would be seen to move through an arc of 180 degrees when transitioning from the fully folded position to the fully unfold position and vice versa. By using the trigonometric formulas provided by VML to repetitively calculate the two-dimensional appearance of the moving panels several times per second and updating the rendering of the combined panel images on the display using the relative z-index values of the panels, the user will perceive the folding and unfolding of the brochure as a substantially smooth movement. In a preferred embodiment, the displayed position of the panel is recalculated ten times per second to provide a relatively smooth appearance of motion to the user. Every 0.1 seconds, the panel position is changed by 3.6 degrees of arc every 0.1 seconds, therefore the 180 degree movement of a panel from the fully folded to the fully unfolded position takes 5 seconds. The speed of the displayed folding and unfolding movement can be readily increased or decreased by varying the number of degrees a panel is assumed to move per unit of time.

Referring now to FIG. 5 in conjunction with FIG. 2A, the edit location function of Indicator 240 will be described. At step 500, the Indicator 240 system monitors for events that may trigger a change in Indicator 240 status. Because the user's mouse will typically be the primary tool employed by the user to select the elements of Document 220 to edit, the most common event that will trigger a status change will be the MouseUp event, indicating that the user has released the mouse button. In addition, any keyboard keys, such as the arrow keys or the tab key, that are given the capability of selecting, resizing or moving a textbox, and therefore causing a change to Indicator 240, are also monitored.

Many events that may be edit-related may also have occurred for reasons unrelated to changing the state of Indicator 240 or selecting an edit location. At step 502, the browser is requested to provide information regarding the event just detected. At step 504, a determination is made whether the user has requested that Indicator 240 change state, i.e., change from a static display to a dynamic display or vice versa. In a preferred embodiment, the location of the mouse cursor over any one of the panels 241-246 at the time of a MouseUp event will cause a change state of Indicator 240. Indicator 240 will remain in the newly selected state until the user decides to change the state again with another mouse click. If requested by the user, the state of Indicator 240 is changed at step 506. As discussed above, this will involve either the initiation or the ceasing of the repetitive panel shape recalculations.

If the browser response from step 502 indicates that no document element is currently selected at step 508, all panels in Indicator 240 are placed in the unhighlighted state at step 510, indicating to the user that no active edit location is currently selected. At step 512, if a document element is selected, EW 225 and EL 226 are obtained from the browser. At step 514, the horizontal midpoint EM 230 of the selected element is calculated as described above. At step 516, if the value of EM 230 is not greater than FPW 227, the midpoint of the selected element is in the left panel of Document 220. At step 518, a determination is made of whether the user is currently viewing the outside or the inside of Document 220. If the user is currently editing the outside, then panel 241 is modified at step 520 to indicate to the user that the current edit operation is being performed on at element on that panel. If the user is currently editing the inside, then panel 244 is modified at step 522. In a preferred embodiment, the color parameter of the VML object for the affected panel is modified to present the panel to the user in a different color. Cross-hatching, a distinctive border, a legend or symbol, or many other ways of indicating the appropriate panel could be employed.

Similarly, at step 524, if the horizontal midpoint of the selected element is not greater than SPW 228, the edit area is located on either panel 243 or 246 depending on the side of the document being viewed. In the remaining situation, where EM 230 is greater than SPW 228, panel 242 or 245 will be highlighted, again depending on the side of the document being edited.

While the invention has been shown and described in one exemplary embodiment, the described embodiment is to be considered as illustrative rather than restrictive. For example, the invention has been discussed above in the context of a system for editing a markup language document, but is not so limited. The principles of the invention can be readily applied to other types of word processing and desktop publishing software programs. Instead of controlling and modifying the Indicator 240 panels based on the location of markup language elements in the document, the Indicator panels could be controlled based on the user's positioning of the edit cursor in the document being edited.

As an alternate embodiment, if the document being designed were configured for horizontal folding instead of vertical folding, Indicator 240 would be configured with panels arranged vertically instead of horizontally as shown in FIG. 2A. In this case, the relevant properties used to determine the appropriate Indicator panel to be highlighted would be the position of the vertical midpoint of the selected element relative to the horizontal panel fold lines measured from the top edge of the document.

As another alternate embodiment, for documents that are intended to undergo post-printing operations that include both vertical folding and horizontal folding, the unfolded document being viewed and edited by the user will appear in Edit Area 210 as a two-dimensional grid of panels. Indicator 240 would present similar two-dimensional representations of the document and both the horizontal and vertical positional properties of the selected element would be employed to determine both the horizontal and vertical location of the element to highlight the appropriate panel in the indicator 240 grid.

As yet another alternate embodiment, instead of highlighting only one indicator 240 panel as determined by the location of the midpoint of a selected element, the overall dimensions of the element could be used to determine whether the element resides entirely within a single panel section or is positioned such that the element falls partially into two, or more, different panels. In this embodiment, if any part of a selected element occupies any part of a panel, that panel would be highlighted in Indicator 240. For any selected element that extends over more than one panel of the document, the corresponding panels in Indicator 240 would all be highlighted to alert the user to the situation.

The scope of the invention, therefore, is as indicated in the following claims and all equivalent methods and apparatus.

What is claimed is:

1. An edit location indication method comprising:
providing an edit area for editing an electronic document intended to be subsequently processed to produce a product;
providing an edit location indicator, the indicator having a plurality of individually modifiable sections, each indicator section corresponding to a section of the product; and
in response to an electronic document edit action, identifying a section of the product corresponding to the location of the edit action, and modifying the appearance of the indicator section corresponding to the identified product section.

2. The method of claim 1 wherein the product is intended to be printed on a plurality of sides and wherein the indicator has a like plurality of areas, each area corresponding to a side of the product.

3. The method of claim 1 wherein the edit action comprises selecting an element in the document for editing.

4. The method of claim 1 wherein the edit action comprises moving an element in the document.

5. The method of claim 1 wherein the edit action comprises inserting an element into the document.

6. The method of claim 1 wherein the edit action comprises positioning the edit cursor in the document.

7. The method of claim 1 further comprising the step of repetitively modifying the appearance of at least one of the indicator sections such that the indicator simulates the folding or unfolding of the product.

8. The method of claim 1 further comprising the steps of:
in response to a first command, repetitively modifying the appearance of at least one of the indicator sections such that the indicator simulates the folding or unfolding of the product, and
in response to a second command, ceasing the repetitive modification of the at least one of the indicator sections.

9. An edit location indicator system for use with a system for editing an electronic document that is intended to be subsequently processed to produce a product, the system comprising:
an indicator having a plurality of individually modifiable sections, each indicator section corresponding to a section of the product; and
means, responsive to an electronic document edit action, for identifying a section of the product corresponding to the location of the edit action and modifying the appearance of the indicator section corresponding to the identified product section.

10. The system of claim 9 wherein the product in intended to be printed on a plurality of sides and wherein the indicator has a like plurality of areas, each area corresponding to a side of the product.

11. The system of claim 9 wherein the product is intended to be folded to create a plurality of panels and wherein each indicator section corresponds to a product panel.

12. The system of claim 11 further comprising means for repetitively modifying the appearance of at least one of the indicator sections such that the indicator simulates the folding and unfolding of the product.

13. The system of 12 further comprising means responsive to a command to activate the means for modifying.

14. The system of 12 further comprising means responsive to a command to deactivate the means for modifying.

15. The system of claim 9 wherein the means for identifying includes means for determining the location of a selected document element.

16. The system of claim 9 wherein the means for identifying includes means for determining the location of the document edit cursor.

17. A computer program for edit location indication, the program comprising:
program code operative to provide an edit area for editing an electronic document intended to be subsequently processed to produce a product;
program code operative to provide an edit location indicator, the indicator having a plurality of individually modifiable sections, each indicator section corresponding to a section of the product, and
program code operative to identify a section of the product corresponding to the location of an electronic document edit action and to modify the appearance of the indicator section corresponding to the identified product section.

18. The computer program of claim 17 wherein the product is intended to be printed on a plurality of side and wherein the program code operative to provide an edit indicator includes program code operative to provide a like plurality of indicator areas, each area corresponding to a side of the product

19. The computer program of claim 17 further comprising program code operative to repetitively modify the appearance of at least one of the indicator sections in response to a first command from a user of the computer program such that the indicator simulates the folding or unfolding of the product.

20. The computer program of claim 17 further comprising program code operative to cease the repetitive modification in response to a second command from the user.

21. The computer program of claim 17 wherein the computer program is embodied on a carrier wave.

22. The computer program of claim 17 wherein the computer program is adapted to run in the browser of a computer system.

23. The computer program of claim 9 wherein the computer code operative to identify a section includes program code operation to determine the location of a selected document element.

24. The computer program of claim 9 wherein the computer code operative to identify a section includes program code operation to determine the location of the edit cursor.
